(19) United States
(12) Patent Application Publication
(10) Pub. No.: US 2025/0371621 A1
(43) Pub. Date: Dec. 4, 2025

(54) SELF-LEARNING SYSTEM FOR DEBTOR SELECTION AND COLLECTOR ACTION OPTIMIZATION

(71) Applicant: Dell Products L.P., Round Rock, TX (US)

(72) Inventors: Saurabh Jha, Austin, TX (US); Sailendu Kumar Patra, Bangalore (IN); Priya Shanmugasundaram, Bangalore (IN)

(21) Appl. No.: 18/676,578

(22) Filed: May 29, 2024

(51) Int. Cl. G06Q 40/06

(52) U.S. Cl. CPC G06Q 40/06

(57) ABSTRACT

A method for managing collection of assets includes obtaining, using an action optimization manager, debtor information, associated with a set of debtor devices each executing on a computing device, from a data source, generating a set of state spaces based on debtor attributes of the debtor information, wherein each of the set of state spaces is a vector comprising debtor features obtained from the debtor information, applying an action-reward analysis on the set of debtor devices using the set of state spaces to generate state-action values for each of the set of debtor devices, applying, using the state action values, a profile analysis to obtain, for each of a set of collection devices, a debtor portfolio, and implementing collection actions based on the debtor portfolio for each of the set of debtor devices.

### BACKGROUND

Credit-line based purchasing power for medium and large-scale businesses may be a used strategy in allowing customers to purchase at ease. However, collecting the money lended in the form of credit is also very crucial as it amounts to a huge sum of money which can be otherwise spent on improving the businesses and reducing the operating expenses. Applying computing systems for the management of such collections may benefit the operation of the businesses

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2 shows a diagram of an action optimization manager in accordance with one or more embodiments of the invention.

FIG. 3 shows a flowchart of a method of implementing collection actions using debtor portfolios in accordance with one or more embodiments of the invention.

FIG. 4 shows an example in accordance with one or more embodiments of the invention.

FIG. 5 shows a diagram of a computing device in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of one or more embodiments of the invention. However, it will be apparent to one of ordinary skill in the art that one or more embodiments of the invention may be practiced without these specific details. In other instances, well-known features have not been described in detail to avoid unnecessarily complicating the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, embodiments disclosed herein include methods and systems for managing collection of assets. Specifically, embodiments of the invention include utilizing an action optimization manager that obtains information from debtors (e.g., entities that owe lent assets to one or more collectors), and apply a debtor scoring model and one or more profile analyses on a set of debtors to generate, for each collector, a debtor portfolio that specifies an order of actions to be taken for communicating with the debtors to collect the borrowed assets. The debtor portfolio for a collector may specify an ordering of the debtors that the corresponding collector is to communicate for obtaining such borrowed assets.

In one or more embodiments, the debtor portfolio is generated by applying action-reward analysis on the set of debtors using state spaces that each specify features of the debtors, optimizing state-action values for each of the set of debtors, and ordering the debtors based on the corresponding state-action values and based on each collector. In this manner, each collector obtains a corresponding debtor portfolio, and each debtor portfolio may specify an ordering tailored to the corresponding collector.

The following describes various embodiments of the invention.

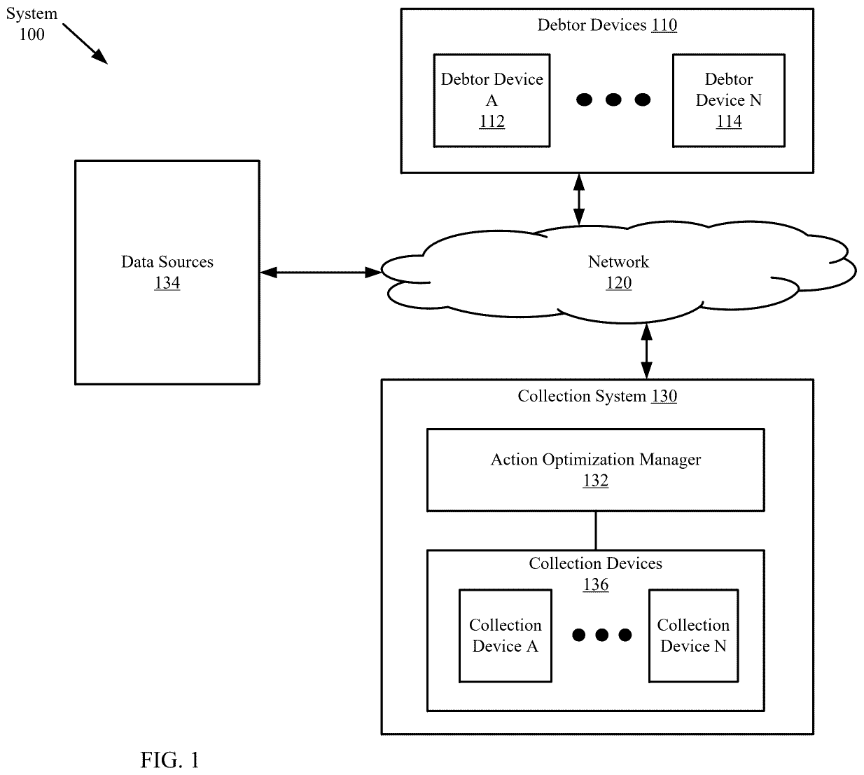

FIG. 1 shows a system in accordance with one or more embodiments of the invention. The system (100) includes any number of debtor devices (110), a network (120), a collection system (130), and one or more data sources (134). The system (100) may include additional, fewer, and/or different components without departing from the scope of the invention. Each component may be operably connected to any of the other component via any combination of wired and/or wireless connections. Each component illustrated in FIG. 1 is discussed below.

In one or more embodiments of the invention, the collection system (130) may provide services to users operating the debtor devices (110). The services may be computer-implemented services such as the transfer of assets as loans. For example, one or more of the collection devices (136) in the collection system (130) may initiate agreements with one or more debtor devices (112, 114) to loan assets to the debtor devices (112, 114).

At any time after lending the assets to the debtor devices (110), the collection devices (136) may desire collecting on such assets (and/or any interest accrued from the loan). For example, one or more of the debtor devices (112, 114) may be past due on any payment for borrowed assets of one or more of the collection devices (136). For example, a first collection device may have lent assets (e.g., money) to three debtors, each operating on a computing device (e.g., a debtor device). Each debtor may be past due on their respective loan payment. There may be an optimal time and order in which the first collection device may desire to contact the three debtors to maximize the amount of return (e.g., expected or total payment) from the three debtors. As such, it may be beneficial to analyze information about the debtor to calculate such optimal time, order, or any other variable.

To perform such calculation, the collection system (130) includes an action optimization manager (132) that processes obtained information to calculate, initiate, and/or otherwise deploy, a set of collection actions to be performed by each of the collection devices (136). The action optimization manager (132) may include functionality for other actions without departing from the invention.

For example, the action optimization manager (132) may include functionality to obtain debtor information from the debtor devices (110), such as computer information (e.g., operating system, a user associated with the debtor device, primary methods of communication for the user, etc.). The debtor information may also be obtained from any number of data sources (134), external to and separate from the debtor devices (110). Each data source may be a third party entity that stores or otherwise includes information associated with the debtor devices (112, 114) and/or any corresponding debtors.

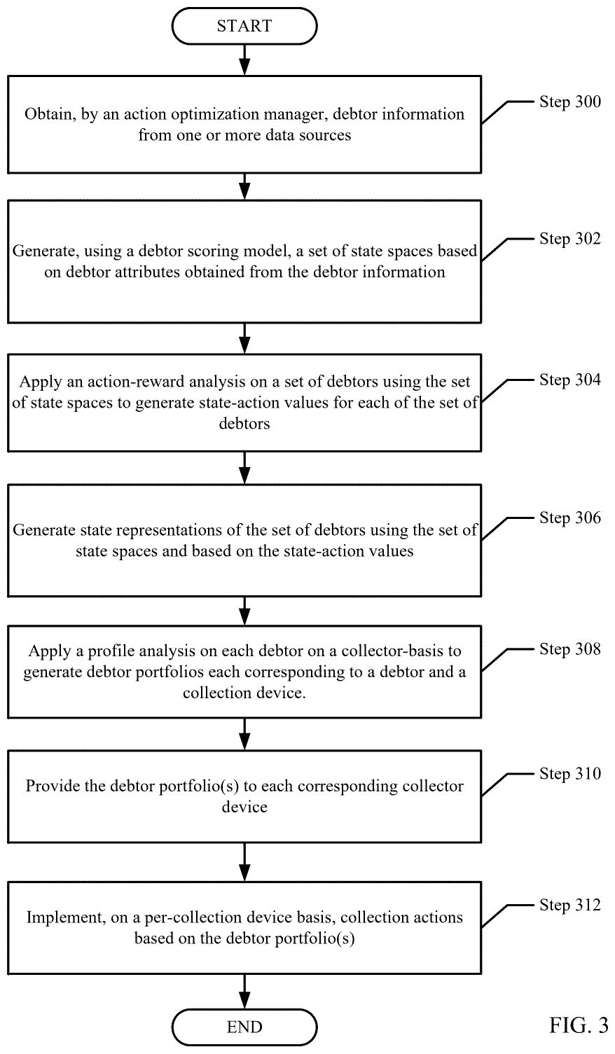

The action optimization manager (132) may further include functionality for performing data processing on the obtained debtor information to generate debtor portfolios, each including a set and ordering of collection actions, providing the debtor portfolios to corresponding collection devices (136), and initiating implementation of the debtor portfolios. The action optimization manager (132) may perform such data processing in accordance with, for example, FIG. 3. The action optimization agent (132) may perform other methods to perform the aforementioned data processing without departing from the invention.

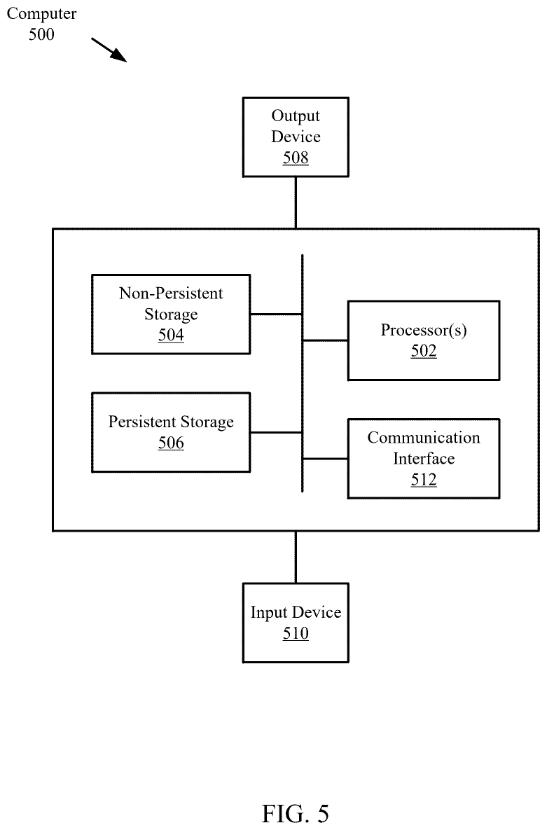

In one or more embodiments, the action optimization manager (132) is implemented as one or more computing devices (e.g., 500, FIG. 5). A computing device may be, for example, a mobile phone, a tablet computer, a laptop computer, a desktop computer, a server, a sale terminal, a distributed computing system, or a cloud resource such as a transaction management unit. The computing device may include one or more processors, memory (e.g., RAM), and persistent storage (e.g., disk drives, SSDs, etc.). The computing device may include instructions, stored on the persistent storage, that when executed by the processor(s) of the computing device cause the computing device to perform the functionality of the action optimization manager (132) (and/or any components illustrated within) described throughout this present disclosure.

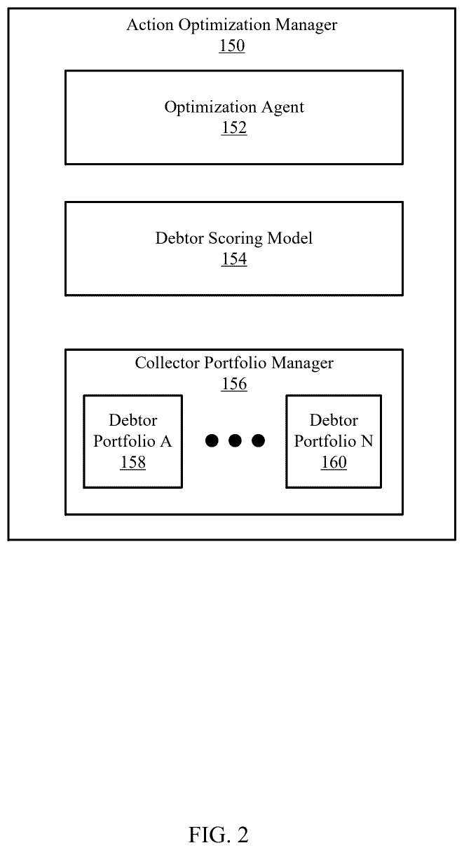

Alternatively, in one or more embodiments of the invention, the action optimization manager (132) is implemented as a logical device. A logical device may utilize the computing resources of any number of computing devices to provide the functionality of the action optimization manager (132) described throughout this present disclosure including, for example, in FIGS. 2 and 3. For additional details regarding the action optimization manager (132), refer to FIG. 2.

In one or more embodiments of the invention, the collection system (130) (and/or any components illustrated within) may be implemented as one or more computing devices (e.g., 500, FIG. 5). A computing device may be, for example, a mobile phone, a tablet computer, a laptop computer, a desktop computer, a server, a sale terminal, a distributed computing system, or a cloud resource such as a transaction management unit. The computing device may include one or more processors, memory (e.g., RAM), and persistent storage (e.g., disk drives, SSDs, etc.). The computing device may include instructions, stored on the persistent storage, that when executed by the processor(s) of the computing device cause the computing device to perform the functionality of the collection system (130) (and/or any components illustrated within) described throughout this present disclosure.

Alternatively, in one or more embodiments of the invention, the collection system (130) (and/or any components illustrated within) may be implemented as logical devices. A logical device may utilize the computing resources of any number of computing devices to provide the functionality of the collection system (130) (and/or any components illustrated within) described throughout this present disclosure.

In one or more embodiments of the invention, the above-mentioned system (100) components may operatively connect to one another through a network (120) (e.g., a local area network (LAN), a wide area network (WAN), a mobile network, a wireless LAN (WLAN), etc.). In one or more embodiments, the network (120) may be implemented using any combination of wired and/or wireless connections. The network (120) may encompass various interconnected, network-enabled subcomponents (not shown) (e.g., switches, routers, gateways, etc.) that may facilitate communications between the above-mentioned system (100) components.

In one or more embodiments of the invention, the network-enabled subcomponents may be capable of: (i) performing one or more communication schemes (e.g., Internet protocol communications, Ethernet communications, communications via any security protocols, etc.); (ii) being configured by the computing devices in the network (120); and (iii) limiting communication(s) on a granular level (e.g., on a per-port level, on a per-sending device level, etc.).

FIG. 2 shows a diagram of an action optimization manager (150) in accordance with one or more embodiments. In one or more embodiments, the action optimization manager (150) includes an optimization agent (152), a debtor scoring model (156), and a collector portfolio manager (156). The action optimization manager (150) may include additional, fewer, and/or different components without departing from the invention.

In one or more embodiments, the optimization agent (152) includes functionality for obtaining debtor information and applying at least a portion of the debtor information to the debtor scoring model (154) to obtain processed information (e.g., in accordance with FIG. 3) and implementing collection actions based on the processed information. The processed information may include, for example, debtor portfolios (158, 160). The processed information may be generated in accordance with, for example, the method shown in FIG. 3.

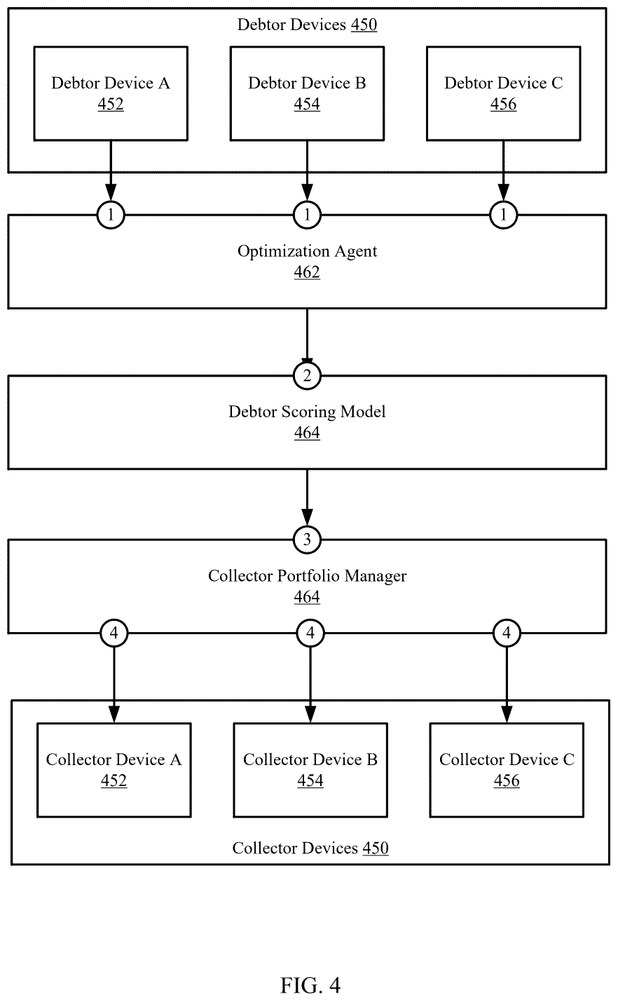

The collector portfolio manager (156) may include functionality for distributing the debtor portfolios (158, 160) to the collection devices (136, FIG. 1) as discussed above. An example of the generation and distribution of the debtor portfolios (158, 160) may be found in, for example, FIG. 4.

In one or more embodiments, the optimization agent (152) and the collector portfolio manager (156) may each be implemented as a software component (e.g., applications of a computing device). In other embodiments, the optimization agent (152) and the collector portfolio manager (156) may each be implemented as portions of a non-transitory computer readable medium that includes computer readable program code, which when executed by a computer processor of the action optimization manager enables the computer processor to perform a method for data processing as illustrated, for example, in FIG. 3, discussed below.

FIG. 3 shows a flowchart of a method of implementing collection actions using debtor portfolios in accordance with one or more embodiments of the invention. The method shown in FIG. 3 may be performed by, for example, an action optimization manager (e.g., 132, FIG. 1). Other components of the system in FIGS. 1-2 may perform all, or a portion, of the method of FIG. 3 without departing from the invention.

While FIG. 3 is illustrated as a series of steps, any of the steps may be omitted, performed in a different order, additional steps may be included, and/or any or all of the steps may be performed in a parallel and/or partially overlapping manner without departing from the invention.

Turning to FIG. 3, in step 300, debtor information is obtained from one or more data sources. In one or more embodiments, the debtor information is obtained from the debtor devices. Debtor information may be further obtained from data sources that store information associated with the debtors and/or the debtor devices.

In step 302, a set of state spaces are generated based on debtor attributes obtained from the debtor information. In one or more embodiments, the state spaces are each a vector that specify one or more debtor attributes associated with a vendor. Examples of debtor attributes, of a debtor, specified in a state space include, but are not limited to: a credit amount, a past due amount, a pay gap, call volumes and duration, other engagements, a point in time (e.g., a day, week, quarter, etc.), and past collector portfolio features. The credit amount may include a total amount provided as debt. The past due amount may be an amount owed to a company that has crossed a due date. The call volumes and duration may specify details of past calls received from collections regarding repayment. The other engagements may specify details of emails and/or other forms of engagement received by debtors from collectors regarding repayment. The past collector portfolio features specify features including a number of accounts, an amount of debt, efforts complexity of cases handled by the collector at a first instance.

In one or more embodiments, the state denoted herein by s_t is a feature vector that describes the debtor, historical contact features, seasonality features, past collector knapsack features. The below table shows a non-exhaustive list of features used for the state space.

In step 304, an action-reward analysis is applied on the set of debtors using the set of state spaces to generate state-action values for each of the set of debtors. The action-reward may be applied by determining a reward for each of the state spaces and determining an action for each of the set of state spaces based on the rewards. The determining of the rewards and actions may be based on a Markov Decision process (MDP), further discussed below.

In one or more embodiments, the actions are binary and are defined as follows:

$${a}_{𝔱} = \{ \begin{matrix}1 , & if the debtor is to be con tacted on t ; \\ 0 & else\end{matrix}$$

The reward rₜ received by the agent on instance t depends on the debt to be recovered from the debtor i to be contacted d_{i,t}, the opportunity cost of contacting debtor i instead of other debtors out and the past knapsack cost of the collector j, m_{j,t-1},

$$\begin{matrix}{r}_{𝔱} = - {k}_{1} * {d}_{i , t} - {k}_{2} * {0}_{i , t} - {k}_{3} * {m}_{j , t - 1} , \\ {o}_{i , t} = {\sum }_{l = 1 , l \neq i}^{N} {d}_{l , t} + α {\sum }_{l = 1 , l \neq i}^{N} {p}_{l , t} ,\end{matrix}$$

where p_{i,t} represents the speed to pay gap for debtor i and is defined below,

$$\begin{matrix}{p}_{i , t} = \{ \begin{matrix}0 , & {p}_{i , t} \leq 0 \\ {p}_{i , t} , & {p}_{i , t} > 0\end{matrix} \\ {m}_{j , t - 1} = {\sum }_{0}^{N} {x}_{i , j} * Q ( {s}_{t - 1} , a ) + {\sum }_{i = 0}^{N} {x}_{ij} * {w}_{i} ( {s}_{t - 1} , a = 1 ) and {x}_{i , j} = \{ 0 , 1 \} ,\end{matrix}$$

where Q denotes the profit of the items that were grouped under the same knapsack j as the current debtor item i at instance t−1. The constants k_1,k_2 and k_3 are determined using domain knowledge and can be tuned to provide weightage to the different parameters in the reward function. The reward is modelled as a negative function of the debt to be recovered, the cost of picking the debtor over other debtors and the cost incurred due to placement of this debtor in a debtor portfolio, using which the reinforcement learning agent will use as penalty and learn to minimize these costs

The above MDP is used to learn the state-action value function Q(s,a). The action value function Q(s,a) denotes the expected cumulative reward that can be obtained by contacting the debtor while at state s and taking action a.

$$Q ( s , a ) = E [ {\sum }_{k = 1}^{T} {γ}^{k} {R}_{t + k} \vert {S}_{t} = s , {A}_{t} = a ]$$

This action value function is maximized to obtain optimal actions and optimal policy π* as follows,

$$π * ( s ) = arg {max}_{a} [ Q ( s , a ) ]$$

Q(s,a) is parameterized by Deep Neural Networks and learnt iteratively through reinforcement learning from rollout data collected through a random behavior policy π_{B}.

In one or more embodiments, the Q(s,a) function is used for the debtor profiles as the value/profit of items (debtor profiles) and the output of the debtor scoring model, w for each debtor profile as the weight of the items to be packed into a number of knapsacks (debtor portfolios) such that the action value function is maximized leading to better debt recovery. Another key feature to note here: the debt selection and the portfolio optimization subtasks are designed interdependently, thereby creating a holistic system that learns from the experiences of each other.

In step 306, a profile analysis is applied on each debtor on a collector-basis to generate debtor portfolios, each corresponding to a debtor and a collection device (e.g., a collector).

In one or more embodiments, The task of assigning the N debtors to M collector portfolios, where every collector j that has a capacity cⱼ is modelled as a multi-knapsack problem. The debtor profiles are modelled as the items to be packed into the knapsack with profit and weight values obtained as the Q value from 5.1.1 and the debtor scores w from the debtor scoring model respectively.

The N debtors are ranked based on the action-value function Q(s,a) and their priority score w provided by the debtor scoring model; these N debtors need to be packed into the portfolios of M collectors such that, the debt recovered is maximized and the capacity constraints of the collector portfolio are not violated. Thus, it's modelled as a stochastic multi-knapsack problem where N items of some expected value Qᵢ(s,a) and weight wᵢ for item i are to be packed into M knapsacks of capacity cⱼ, such that,

$$max {\sum }_{j = 1}^{M} {\sum }_{i = 1}^{N} ( {Q}_{i} ( s , a ) * {x}_{ij} ) ; and {w}_{i} * {x}_{ij} < {c}_{j} \& {x}_{ij} ∈ \{ 0 , 1 \}$$

The stochastic multi-knapsack problem is formulated as a MDP and solved using reinforcement learning. The reinforcement learning agent prescribes the optimal packing scheme for the N debtor profiles as M disjoint subsets representing the collector portfolio. The state, action, reward formulations are described as follows,

State Space: The state denoted by s_τ\hat{ } is a feature vector that describes the current knapsack features, like the current capacity, profit to item ratio, the weight to item ratio and the profit to weight ratio. The below table shows a non-exhaustive list of features used for the state space,

TABLE 2
State Space Features for Collector Portfolio Allocation

| Name | Description |
|---|---|
| Knapsack Capacities | Current capacity values for each of the different knapsacks |
| | [c₁, c₂, ... , c_{M}] ordered in descending. |
| Cumulative Value of items in | Summation of values of items in the knapsack for each knapsack |
| Knapsack | [q₁, q₂, ... , q_{M}] |
| Cumulative Weight of items in | Summation of weights of items in the knapsack for each knapsack |
| Knapsack | $[ {w}_{1}^{′} , {w}_{2}^{′} , … , {w}_{M}^{′} ]$ |
| Value to Weight Ratio of items | $The ratios of the value of the item i ( {Q}_{i} ) to the weight of the item i ( {w}_{i}^{′} )$ |
| | $for each item [ \frac{{Q}_{1}}{{w}_{1}^{′}} , \frac{{Q}_{2}}{{w}_{2}^{′}} , … , \frac{{Q}_{N}}{{w}_{N}^{′}} ]$ |
| Normalized Profit of items | The profit of each item normalized with respect to highest profit, |
| | ${Q}_{max} for each item [ \frac{{Q}_{1}}{{Q}_{max}} , \frac{{Q}_{2}}{{Q}_{max}} , … , \frac{{Q}_{N}}{{Q}_{ma x}} ]$ |
| Weight of item to Capacity of | $Weight of item i {w}_{i}^{′} to the capacity of the knapsack j the item i$ |
| Knapsack ratio | $is placed for all items , {[ \frac{{w}_{i}^{′}}{{c}_{j}} ]}_{i = 1 , 2 , … , N} where j ∈ \{ 1 , 2 , … , M \}$ |

In the above definitions ‘debtor profiles’ are referred to as ‘items’ and the ‘collector portfolios’ (also referred to as debtor portfolios) are referred to as knapsacks, where we have N debtor profiles to be allocated to M collector portfolios where each portfolio j has a capacity c_j. The different features in s_τ are defined as,

$$\begin{matrix}{q}_{j} = {\sum }_{i = 1}^{N} {x}_{ij} {Q}_{i} \\ {w}_{j}^{′} = {\sum }_{i = 1}^{N} {x}_{ij} {w}_{i}\end{matrix}$$

Where Qᵢ is the state action value for debtor i learnt using reinforcement learning and wᵢ is the debtor score from the debtor scoring model.

Action Space: The actions are discrete in nature and are defined as follows,

$${a}_{τ} = \{ 1 , 2 , … , N \}$$

where a denotes the item to be packed into the knapsack which has maximum remaining capacity c_j.

Reward: The reward r_{τ} received by the agent on instance t depends on the packing decision, as we need to reward the agent in picking an empty portfolio with adequate capacity to hold the debtor profile, while penalize it when it allocates a full portfolio (wᵢ>cⱼ) or when it tries to allocate an item for more than once (a>[I]), where I is the index set of all items,

$${r}_{τ} = \{ \begin{matrix}\frac{{Q}_{i}}{{w}_{i} {c}_{j}} & {w}_{i} \leq {c}_{j} , \\ - \frac{{w}_{i}}{{c}_{j}} & {w}_{i} > {c}_{j} , \\ - ρ & a > \vert I \vert .\end{matrix}$$

The above defined MDP can be used to learn the optimal policy for packing debtors into debtor portfolios using actor-critic methods such as A3C for standalone purposes.

The optimal policy for packing Ty is learnt for this subproblem based on the MDP definitions.

The reward of the selection sub-task is modelled to be dependent on the knapsack features of instance t−1. This reward captures the cost of being packed into a knapsack j as mⱼ described as follows,

$${m}_{j , t - 1} = {\sum }_{i = 0}^{N} {x}_{ij} * {Q}_{i} ( {s}_{t - 1} , a = 1 ) + {\sum }_{i = 0}^{N} {x}_{ij} * {w}_{i} ( {s}_{t - 1} , a = 1 ) and {x}_{ij} = \{ 0 , 1 \} ,$$

where Qᵢ(sₜ₋₁,a) is the state-action value for the debtor i predicted at instance t−1. The state-action value function describes the cumulative expected reward that can be obtained by contacting debtor i at state sₜ₋₁. Thus m; gives the total expected reward that was to be obtained from knapsack j aka collector j and the cumulative debtor scores in the knapsack j, where the current debtor i was placed during instance t−1. This information may quantify the impact of placing debtor i in knapsack j as it depends on the knapsack's profitability (debtor values) and the heaviness of the knapsack (debtor priorities).

The state Sₜ of the selection task is also dependent on the allocation subtask carried out at instance t−1, as the state is also represented by past collector portfolio features which includes number of accounts, amount of money, engagement efforts, expertise and complexity of cases handled by collector at t−1. Thus, this state-definition clarifies whether debtor-collector pair i−j is optimal to the collection process taking into consideration the collector availability and tenure.

Based on the total expected rewards mⱼ, the optimal knapsack for each collector may be selected as the one with the highest total expected reward for a given collector. The selected knapsack may be a collector portfolio (also referred to as a debtor portfolio for comprising an ordering of one or more debtors). The debtor portfolio may specify an ordering of debtors and one or more collection actions to be performed by a collector to obtain the requested payment from the ordered debtors. The collection actions may include, for example, a form of engagement such as a call, email, and/or mailed letter.

In step 308, the debtor portfolios are provided to the corresponding collector devices. In one or more embodiments, each debtor portfolio is associated with a collector device. The debtor portfolios, as discussed above, may each specify a set of collection actions to be performed by the corresponding collection actions.

In step 310, one or more collection actions are implemented on a per-collection device basis and based on the debtor portfolios. For example, each collector device may implement the collection actions of its corresponding debtor portfolio by contacting the debtor devices in the order specified in the debtor portfolio and in the method of communication specified therein.

To further clarify embodiments of the invention described throughout this disclosure, a non-limiting example is provided in FIG. 4.

### EXAMPLE

Consider a scenario in which a set of debtors have borrowed money from a business that includes three collection devices, each operated by a user. The business would like to optimize an order for contacting the debtors to collect past due assets.

FIG. 4 shows an example system in accordance with one or more embodiments of the invention. The example system illustrates the flow of data or other information using arrows between components of the example system. The components may be, for example, modules, devices, or data structures.

The example system includes a set of debtor devices (450). The debtor devices (452, 454, 456) each are operated by a user that owes money to the business. Debtor information is provided from the debtor devices (450) to an optimization agent (462) [1]. The optimization agent (462) is an embodiment of an optimization agent (152, FIG. 2) discussed above.

The debtor information is processed by applying debtor attributes of the debtor information to a debtor scoring model (464) as discussed in FIG. 3 [2]. The debtor scoring model (464) may generate one or more weights to be applied to solving a stochastic binary multi-knapsack problem in accordance with FIG. 3. The generated weights are provided to the collector portfolio manager (466) [3], which processes the generated weights and the debtor attributes to apply an action-reward analysis for state spaces corresponding to the debtor attributes to obtain three debtor portfolios. Each debtor portfolio species an order of the debtor devices (452, 454, 456) to be contacted by one of the collector devices (472, 474, 476). A first debtor portfolio specifies an ordering for contact tailored for collector device A (472); a second debtor portfolio specifies an ordering for contact tailored for collector device B (474); and a third debtor portfolio specifies an ordering for contact tailored for collector device C (476). The debtor portfolios are provided to the corresponding collector devices (472, 474, 476) [4].

In response to the obtained debtor portfolios, each collector device (472, 474, 476) implements the collection actions specified in the corresponding debtor portfolios. Specifically, each collector device (472, 474, 476) includes functionality for contacting the debtor devices (450) in the order specified in its corresponding debtor portfolio.

### END OF EXAMPLE

As discussed above, embodiments of the invention may be implemented using computing devices. FIG. 5 shows a diagram of a computing device in accordance with one or more embodiments of the invention. The computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (not shown) (e.g., a local area network (LAN), a wide area network (WAN) such as the Internet, mobile network, or any other type of network) and/or to another device, such as another computing device.

In one embodiment of the invention, the computing device (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

Embodiments of the invention may provide a system and method for optimizing resource use for the collection of assets. Specifically, embodiments of the invention provide a collection system the most efficient method for contacting the debtors, using debtor information to calculate the optimal set of collection actions. Such calculation may improve the collection system overall.

Thus, embodiments of the invention may address the problem of limited computing resources in a distributed system. The problems discussed above should be understood as being examples of problems solved by embodiments of the invention of the invention and the invention should not be limited to solving the same/similar problems. The disclosed invention is broadly applicable to address a range of problems beyond those discussed herein.

One or more embodiments of the invention may be implemented using instructions executed by one or more processors of a computing device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as of the invention. Accordingly, the scope of the invention should be limited only by the attached claims.

What is claimed is:

1. A method for managing collection processing, the method comprising:
obtaining, using an action optimization manager, debtor information, associated with a set of debtor devices each executing on a computing device, from a data source;
generating a set of state spaces based on debtor attributes of the debtor information, wherein each of the set of state spaces is a vector comprising debtor features obtained from the debtor information;
applying an action-reward analysis on the set of debtor devices using the set of state spaces to generate state-action values for each of the set of debtor devices;
applying, using the state action values, a profile analysis to obtain, for each of a set of collection devices, a debtor portfolio; and
implementing collection actions based on the debtor portfolio for each of the set of debtor devices.

2. The method of claim 1, wherein applying the action-reward analysis comprises:
determining a reward for each of the set of state spaces; and
determining, based on the reward, an action for each of the set of state spaces,
wherein the state-action values are associated with the action of each of the set of state spaces and the state spaces.

3. The method of claim 2, wherein determining the reward and determining the action are based on a Markov Decision process.

4. The method of claim 1, wherein applying the profile analysis comprises:
generating debtor listings for a collection device of the set of collection devices;
determining knapsack values each associated with one of the debtor listings; and
selecting, for the collection device, a debtor listing with highest action-reward value, wherein the selected debtor listing is the debtor portfolio for the collection device.

5. The method of claim 4, wherein determining the knapsack values is performed by solving a stochastic binary multi-knapsack problem.

6. The method of claim 1, further comprising: after implementing the collection actions, updating the action-reward analysis based on results of the implementing to obtain an updated action-reward analysis.

7. The method of claim 6, further comprising:
obtaining, using the action optimization manager, second debtor information, associated with the set of debtor devices;
generating a second set of state spaces based on second debtor attributes of the second debtor information;
applying the updated action-reward analysis on the set of debtor devices using the second set of state spaces to generate second state-action values for each of the set of debtor devices;
applying, using the second state action values, an updated profile analysis to obtain, for each of a set of collection devices, a second debtor portfolio; and
implementing new collection actions based on the second debtor portfolio for each of the set of debtor devices.

8. A non-transitory computer readable medium comprising computer readable program code, which when executed by a computer processor enables the computer processor to perform a method for managing collection processing, the method comprising:
obtaining, using an action optimization manager, debtor information, associated with a set of debtor devices each executing on a computing device, from a data source;
generating a set of state spaces based on debtor attributes of the debtor information, wherein each of the set of state spaces is a vector comprising debtor features obtained from the debtor information;
applying an action-reward analysis on the set of debtor devices using the set of state spaces to generate state-action values for each of the set of debtor devices;
applying, using the state action values, a profile analysis to obtain, for each of a set of collection devices, a debtor portfolio; and
implementing collection actions based on the debtor portfolio for each of the set of debtor devices.

9. The non-transitory computer readable medium of claim 8, wherein applying the action-reward analysis comprises:
determining a reward for each of the set of state spaces; and
determining, based on the reward, an action for each of the set of state spaces,
wherein the state-action values are associated with the action of each of the set of state spaces and the state spaces.

10. The non-transitory computer readable medium of claim 9, wherein determining the reward and determining the action are based on a Markov Decision process.

11. The non-transitory computer readable medium of claim 8, wherein applying the profile analysis comprises:
generating debtor listings for a collection device of the set of collection devices;
determining knapsack values each associated with one of the debtor listings; and
selecting, for the collection device, a debtor listing with highest action-reward value,
wherein the selected debtor listing is the debtor portfolio for the collection device.

12. The non-transitory computer readable medium of claim 11, wherein determining the knapsack values is performed by solving a stochastic binary multi-knapsack problem.

13. The non-transitory computer readable medium of claim 8, further comprising: after implementing the collection actions, updating the action-reward analysis based on results of the implementing to obtain an updated action-reward analysis.

14. The non-transitory computer readable medium of claim 13, further comprising:
obtaining, using the action optimization manager, second debtor information, associated with the set of debtor devices;
generating a second set of state spaces based on second debtor attributes of the second debtor information;
applying the updated action-reward analysis on the set of debtor devices using the second set of state spaces to generate second state-action values for each of the set of debtor devices;
applying, using the second state action values, an updated profile analysis to obtain, for each of a set of collection devices, a second debtor portfolio; and
implementing new collection actions based on the second debtor portfolio for each of the set of debtor devices.

15. A system, comprising:
a processor; and
memory including instructions, which when executed by the processor, perform a method comprising:
obtaining, using an action optimization manager, debtor information, associated with a set of debtor devices each executing on a computing device, from a data source;
generating a set of state spaces based on debtor attributes of the debtor information, wherein each of the set of state spaces is a vector comprising debtor features obtained from the debtor information;
applying an action-reward analysis on the set of debtor devices using the set of state spaces to generate state-action values for each of the set of debtor devices;
applying, using the state action values, a profile analysis to obtain, for each of a set of collection devices, a debtor portfolio; and
implementing collection actions based on the debtor portfolio for each of the set of debtor devices.

16. The system of claim 15, wherein applying the action-reward analysis comprises:
determining a reward for each of the set of state spaces; and
determining, based on the reward, an action for each of the set of state spaces,
wherein the state-action values are associated with the action of each of the set of state spaces and the state spaces.

17. The system of claim 16, wherein determining the reward and determining the action are based on a Markov Decision process.

18. The system of claim 15, wherein applying the profile analysis comprises:
generating debtor listings for a collection device of the set of collection devices;
determining knapsack values each associated with one of the debtor listings; and
selecting, for the collection device, a debtor listing with highest action-reward value, wherein the selected debtor listing is the debtor portfolio for the collection device.

19. The system of claim 18, wherein determining the knapsack values is performed by solving a stochastic binary multi-knapsack problem.

20. The system of claim 19, further comprising:
after implementing the collection actions:
updating the action-reward analysis based on results of the implementing to obtain an updated action-reward analysis
obtaining, using the action optimization manager, second debtor information, associated with the set of debtor devices;
generating a second set of state spaces based on second debtor attributes of the second debtor information;
applying the updated action-reward analysis on the set of debtor devices using the second set of state spaces to generate second state-action values for each of the set of debtor devices;
applying, using the second state action values, an updated profile analysis to obtain, for each of a set of collection devices, a second debtor portfolio; and
implementing new collection actions based on the second debtor portfolio for each of the set of debtor devices.
